(19) United States
(12) Patent Application Publication
(10) Pub. No.: US 2010/0238461 A1
(43) Pub. Date: Sep. 23, 2010

(54) Profile Selection Mechanism

(76) Inventors: James Anthony Chauvin, Frederick, CO (US); Jason Charles Kenneth Walp, Louisville, CO (US)

Correspondence Address: InfoPrint Solutions/ Blakely, 1279 Oakmead Parkway, Sunnyvale, CA, 94085-4040, US

(21) Appl. No.: 12/405,769

(22) Filed: Mar. 17, 2009

(51) Int. Cl. H04N 1/60

(52) U.S. Cl. 358/1.9

(57) ABSTRACT

A printing system includes a print system to print data received at the printing system, a color image recording device to measure one or more control patches from the data printed at the print system and a control unit to compare measurement data from the control patches to data from available International Color Consortium (ICC) profiles to select an appropriate ICC profile corresponding the control patches.

### FIELD OF THE INVENTION

The invention relates generally to the field of printing systems. More particularly, the invention relates to selecting ink profiles in a color printing system.

### BACKGROUND

Growth in color management has resulted in an increase in software packages that are used to generate International Color Consortium (ICC) profiles. ICC profiles describe color attributes of a particular device or viewing requirement by defining a mapping between a source or target color space and a profile connection space (PCS), such as either CIELAB (L*a*b*) or CIEXYZ.

Typically, a printer operator uses a graphical user interface to select a particular color profile for one or more print jobs. However, operators often select an incorrect ICC profile for a paper or ink set that has been loaded since each ICC profile is valid only for a given set of printing conditions. Improper selection of an ICC profile results in poor print quality of a print job. Thus, operators must often undergo a time consuming process of becoming trained as to how to properly select ICC profiles for print jobs.

Accordingly, a mechanism for automatically selecting ICC profiles is desired.

### SUMMARY

In one embodiment, a printing system is disclosed. The printing system includes a print system to print data received at the printing system, a color image recording device to measure one or more control patches from the data printed at the print system and a control unit to compare measurement data from the control patches to data from available International Color Consortium (ICC) profiles to select an appropriate ICC profile corresponding the control patches.

Another embodiment discloses a method of a color image recording device measuring one or more control patches from print data, a control unit comparing measurement data from the control patches to data from available International Color Consortium (ICC) profiles and the control unit selecting an ICC profile having data values closest to values of the measurement data.

### BRIEF DESCRIPTION OF THE DRAWINGS

A better understanding of the present invention can be obtained from the following detailed description in conjunction with the following drawings, in which:

FIG. 1 illustrates one embodiment of a data processing system network;

FIG. 2 illustrates one embodiment of a printer;

FIG. 3 illustrates one embodiment of a print system; and

FIG. 4 is flow diagram illustrating one embodiment of selecting an ICC profile.

### DETAILED DESCRIPTION

A mechanism for automatically selecting ICC profile is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

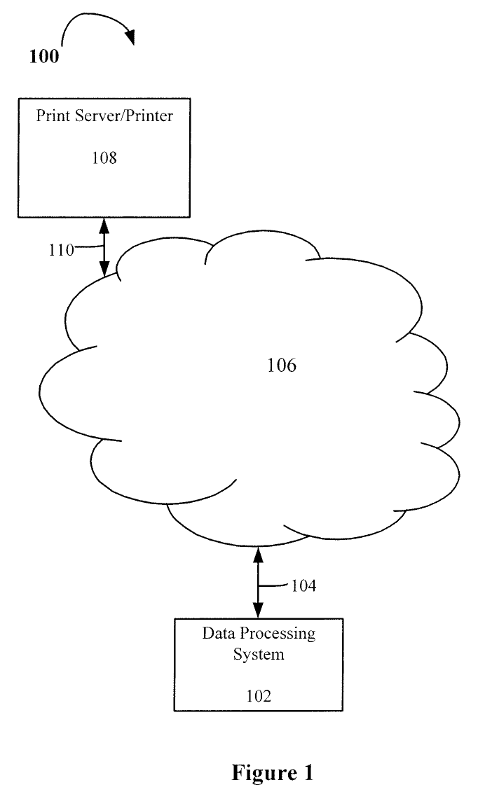

FIG. 1 illustrates one embodiment of a data processing system network 100. Network 100 includes a data processing system 102, which may be either a desktop, host computer or a mobile data processing system, coupled via communications link 104 to network 106. In one embodiment, data processing system 102 is a conventional data processing system including a processor, local memory, nonvolatile storage, and input/output devices such as a keyboard, mouse, trackball, and the like, all in accordance with the known art. In one embodiment, data processing system 102 includes and employs the Windows operating system or a similar operating system and/or network drivers permitting data processing system 102 to communicate with network 106 for the purposes of employing resources within network 106.

Network 106 may be a local area network (LAN) or any other network over which print requests may be submitted to a remote printer or print server. Communications link 104 may be in the form of a network adapter, docking station, or the like, and supports communications between data processing system 102 and network 106 employing a network communications protocol such as Ethernet, the AS/400 Network, or the like.

According to one embodiment, network 106 includes a print server/printer 108 serving print requests over network 106 received via communications link 110 between print server/printer 108 and network 106. The operating system on data processing system 102 is capable of selecting print server/printer 108 and submitting requests for services to print server/printer 108 over network 106. Print server/printer 108 includes a print queue for print jobs requested by remote data processing systems 102. Further, print server/printer 108 includes a control unit to perform operations associated with printing a request.

Although described as incorporated within the same entity, other embodiments may include the print server and the printer as being physically separate components. Therefore, the data processing system network 100 depicted in FIG. 1 is selected for the purposes of explaining and illustrating the present invention and is not intended to imply architectural limitations. Those skilled in the art will recognize that various additional components may be utilized in conjunction with the present invention.

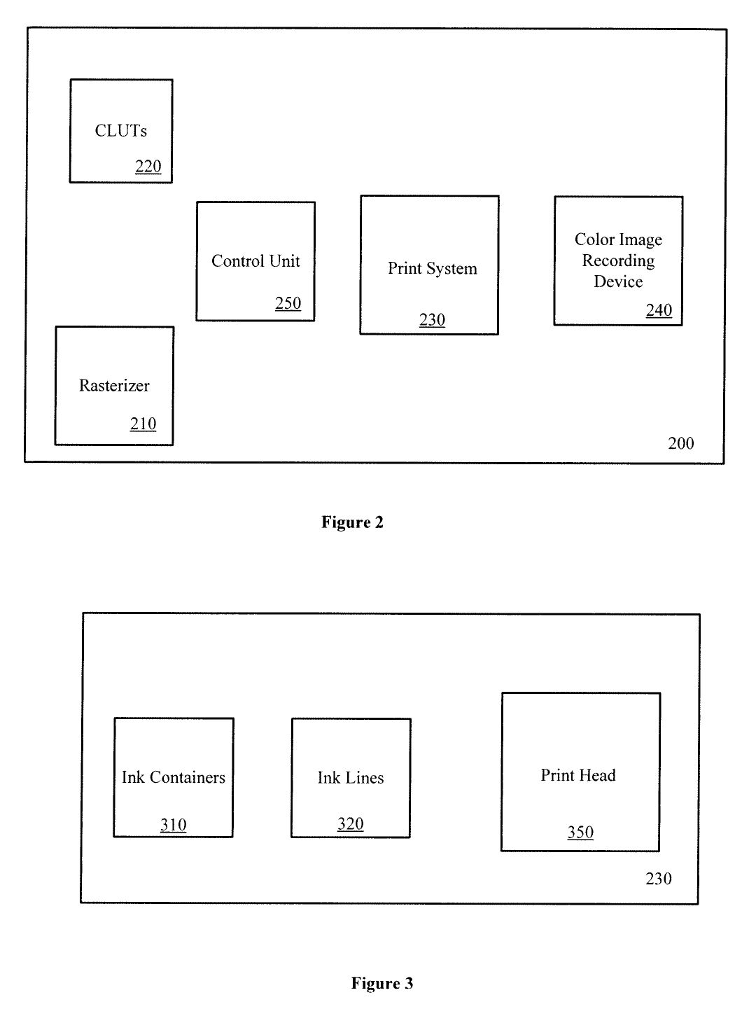

FIG. 2 illustrates one embodiment of a printer 200. In one embodiment, printer 200 is the printing component of print server/printer 108. Printer 200 includes a rasterizer 210 that is implemented to convert vector information received at printer 200 into a raster format. Particularly, rasterizer 210 generates a raster scan of a received image that is to be stored as scan line data in a memory array (not shown).

Printer 200 also includes color lookup tables (CLUTs) 220. CLUTs 220 support ICC profiles used in printer 200 to enable the use of different color transforms, where each transform is tailored for a different effect. According to one embodiment, each profile includes up to 6 CLUT's, three for input (AtoB tables, which convert from device space to PCS, and three for output (BtoA tables, that convert from PCS to device space).

Printer 200 includes a print system 230 that physically applies print job data on a print medium. FIG. 3 illustrates one embodiment of a print system 230. In one embodiment, print system 230 includes ink containers 310, ink lines 320 and a print head 350. Ink containers 310 include one or more ink colors that supply one or more ink reservoirs to print head 350 via ink lines 320. In one embodiment, ink containers 310 are bottles. However in other embodiments, ink containers 210 may be a bladder, cartridge or other type of supply containers.

Print head 350 includes a printing element that applies ink to a print medium. According to one embodiment, print head 350 is a wide-array inkjet print head that employs multiple sets of nozzles that are implemented to spray droplets of ink onto a sheet of paper in order to execute a print job. However, print head 350 may include other types of ink jet print heads, as well as a moving print head design.

Referring back to FIG. 2, printer 200 further includes a color image recording device 240. Color image recording device 240 is placed above the print path of print system 230 in order to measure control patches (e.g., color) from the output of print head 350. According to one embodiment the control patch measurements are used to select a proper ICC profile for a particular printer 200 setting. In one embodiment, color image recording device 240 includes a camera that captures an image prior to measuring the control patch. However in other embodiments, color image recording device 240 may be implemented with a scanner, photo spectrophotometer, or any other type of imaging device.

Control unit 250 is included with in printer 200 to control the operation of print system 230. In addition, control unit receives the measurement data from color image recording device 240. In such an embodiment, control unit 250 converts the measured results from the device space (e.g., cyan, magenta, yellow, and black (CMYK)) to the PCS space (e.g., L*a*b*). The measured results are then compared to available ICC profiles to find the best profile for the given response of the control patches.

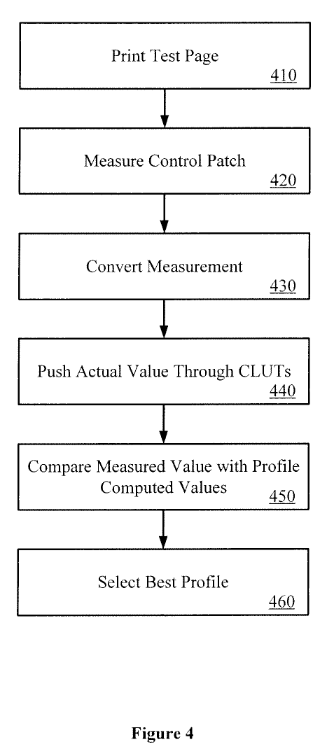

FIG. 4 is flow diagram illustrating one embodiment of a process for selecting an ICC profile. At processing block 410, a test page is printed at print system 230 in response to a change at printer 200 (e.g., paper change, settings change, etc.). In one embodiment, an operator uses a GUI at print server/printer 108 to generate the data for the test page. However, in other embodiments, the operator may generate the test page at a data processing system 102

At processing block 420, one or more control patches printed on the test page is measured by color image recording device 240. At processing block 430, the measured control patch data is converted from CMYK to L*a*b* data. At processing bock 440, CMYK values from the print data used to generate the test patch is pushed through the AtoB tables of the CLUTs 220 to generate L*a*b* values for each available ICC profile. At processing block 450, the measured L*a*b* data values are compared to the generated L*a*b* values.

At processing block 460, control unit 250 selects the ICC profile having the generated L*a*b* values that are closest to the measured L*a*b* values. According to one embodiment, a mean Delta-E (dE) of each of the generated L*a*b* values, where the ICC profile corresponding to the lowest metric is selected. dE is a difference metric having a single number that represents the distance between two colors. A dE of 1.0 is the smallest color difference the human eye can see. Thus, a dE less than 1.0 is imperceptible dE. However in other embodiments, other types of difference metrics may be implemented to select the ICC profile having the generated L*a*b* values that are closest to the measured L*a*b* values.

Once the closest ICC profile is selected, printer 200 is available to print the highest quality print job possible for the current settings and paper. In a further embodiment, the GUI prompts the operator to generate a new ICC profile if none of the ICC profiles of L*a*b* values are within a predefined range of the measured L*a*b* values.

The above-described ICC profile selection mechanism reduces errors associated with incorrectly selected ICC profiles, as well as reducing set up time to select the best existing profile.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A printing system comprising:
a print system to print data received at the printing system;
a color image recording device to measure one or more control patches from the data printed at the print system; and
a control unit to compare measurement data from the control patches to data from available International Color Consortium (ICC) profiles to select an appropriate ICC profile corresponding the control patches.

2. The printing system of claim 1 wherein the control unit converts the measurement data from a device space to a profile connection space (PCS) prior to comparing the measurement data.

3. The printing system of claim 2 wherein the control unit pushes device space values from the print data used to generate the test patch through one or more color lookup tables (CLUTs) to generate PCS values for each available ICC profile.

4. The printing system of claim 3 wherein the control unit compares the generated PCS values to PCS values corresponding to the measurement data.

5. The printing system of claim 4 wherein the control unit selects an ICC profile corresponding to the generated PCS values that are closest to the PCS values corresponding to the measurement data.

6. The printing system of claim 5 further comprising a graphical user interface (GUI) to prompt an operator to facilitate generation of a new ICC profile if none of the generated PCS values are within a predetermined range of the measured PCS values.

7. The printing system of claim 3 wherein the device space comprises a cyan, magenta, yellow, and black (CMYK) space and the PCS space comprises a L*a*b* space.

8. The printing system of claim 1 wherein the color image recording device is a camera that captures images of the control patches.

9. The printing system of claim 1 wherein the color image recording device is a scanner.

10. The printing system of claim 1 wherein the color image recording device is a photo spectrophotometer.

11. A method comprising:
color image recording device measuring one or more control patches from print data;
a control unit comparing measurement data from the control patches to data from available International Color Consortium (ICC) profiles; and
the control unit selecting an ICC profile having data values closest to values of the measurement data.

12. The method of claim 11 further comprising printing a print job using the selected ICC profile.

13. The method of claim 11 further comprising converting the measurement data from a device space to a profile connection space (PCS) prior to comparing the measurement data.

14. The method of claim 13 further comprising pushing device space values from the print data used to generate the test patch through one or more color lookup tables (CLUTs) to generate PCS values for each available ICC profile;

15. The method of claim 14 further comprising:
comparing the generated PCS values to PCS values corresponding to the measurement data; and
selecting an ICC profile corresponding to the generated PCS values that are closest to the PCS values corresponding to the measurement data.

16. The method of claim 15 further comprising generating a new ICC profile if none of the generated PCS values are within a predetermined range of the PCS values corresponding to the measurement data.

17. An article of manufacture comprising a machine-readable medium including data that, when accessed by a machine, cause the machine to perform operations comprising:
measuring one or more control patches from print data;
comparing measurement data from the control patches to data from available International Color Consortium (ICC) profiles; and
selecting an ICC profile having data values closest to values of the measurement data.

18. The article of manufacture of claim 17, wherein the machine-accessible medium includes data that causes the machine to perform further operations comprising converting the measurement data from a device space to a profile connection space (PCS) prior to comparing the measurement data.

19. The article of manufacture of claim 18, wherein the machine-accessible medium includes data that causes the machine to perform further operations comprising pushing device space values from the print data used to generate the test patch through one or more color lookup tables (CLUTs) to generate PCS values for each available ICC profile;

20. The article of manufacture of claim 19, wherein the machine-accessible medium includes data that causes the machine to perform further operations comprising:
comparing the generated PCS values to PCS values corresponding to the measurement data; and
selecting an ICC profile corresponding to the generated PCS values that are closest to the PCS values corresponding to the measurement data.
